(19) United States
(12) Patent Application Publication
(10) Pub. No.: US 2002/0020268 A1
(43) Pub. Date: Feb. 21, 2002

(54) Punch

(75) Inventors: Makoto Mori, Tokyo (JP); Hideyuki Suzuki, Tokyo (JP)

Correspondence Address: OLIFF & BERRIDGE, PLC, P.O. BOX 19928, ALEXANDRIA, VA, 22320, US

(73) Assignee: CARL MANUFACTURING CO., LTD.

(21) Appl. No.: 09/767,864

(22) Filed: Jan. 24, 2001

(30) Foreign Application Priority Data
Nov. 29, 1999 (JP) HEI 11-338123

(51) Int. Cl. B26F 1/14

(52) U.S. Cl. 83/167; 83/618; 83/633

(57) ABSTRACT

A punch for piercing sheets of paper has a waste receptacle which has an increased volume and which can be easily removed without removing the punch. The punch includes a base and operation stands that support a handle to be pulled towards the base. Pipe rod blades are depressed by pulling the handle toward the base to pierce the paper sheets and thus create punch waste. An opening for discharging the punch waste is provided on a side of each of the operation stands above the pipe rod blades. A waste receptacle for collecting the punch waste is provided on the base so that the waste receptacle communicates with the opening.

### BACKGROUND OF THE INVENTION

1. Field of the Invention

The present invention relates to a punch that is to pierce sheets of paper.

2. Description of the Related Arts

Paper documents in general are easier to read when they are bound. One of known methods to bound sheets of paper is to use strings or metals after punching the sheets of paper.

As a paper punch, there have been one comprising pipe-rod blades the rod of which is hollow and formed with a circular blade at the end thereof and a given stand to put sheets of paper thereon. In this punch, the pipe-rod blades are disposed above or under the sheets of paper and adapted to punch circular holes in the sheets of paper by pressing the pipe-rod against the sheets of paper. Circular punch wastes are discharged through an inner hole of the pipe-rod blade and collected in a waste receptacle attached.

In a conventional punch 1 shown in FIG. 14, an operation stand 3 is provided on one end of a base 2 so as to be a continuation to the base 2, and the other side of the base 2 is used to put the sheets of paper thereon. In an upper portion of the operation stand 3, a handle 5 is provided while pivoted on a rotating shaft 4. The handle 5 is held approximately vertical by being biased with a spring but can be pulled toward the base 2.

Furthermore, as shown in FIGS. 14 and 15, a projection portion 3a is formed on the operation stand 3 which projects above the sheets of paper put on the base 2. When the sheets of paper are set on the punch 1, the sheets of paper are positioned by abutting one ends of the sheets of paper to a stopper 6 that is on the far side of the projection portion 3a and a gauge 7 is used to set the widthwise position of the sheets.

At a ceiling portion 3b of the projection portion 3a, a plate 8 for pressing the sheets of paper with springs (not shown) and a pair of hollow pipe rod blades 9 looking downward through two holes formed in the plate 8 are arranged. Corresponding these-two pipe rod blades a pair of recesses 2a are provided on the base 2 below and disc rod guards 10 made of a synthetic resin are disposed therein. Furthermore, a waste receptacle 11 is accommodated in the operation stand 3.

As shown in FIG. 15, a wheel gear 12 is connected to the rotating shaft 4 connected to the handle 5 and engaged with a rack 13 that is capable of moving up and down. To a lower end of the rack 13, a cylindrical rod holder 14 to which the pipe rod blade 9 is to be fitted is connected. And the pipe rod blade 9 is inserted in an inner hole of the rod holder 14 and fixed by a screw 15 screwed laterally from the side of the rod holder 14.

Furthermore, an upper portion of the inner hole of the rod holder 14 is communicated with a discharge guide 16 opened to the back and with the waste receptacle 11 in the operation stand through a sliding plate 17.

In using this punch 1, the sheets of paper are put on the base 2 while abutting the front end of the sheets of paper against the stopper 6 and the sides of the sheets of paper against the gauge 7 for defining the widthwise positioning. Subsequently, the handle 5 is turned toward the base, whereby the plate 8 and the pair of pipe rod blades 9 descend, and are brought into contact with the sheets of paper and pressed against them. By further turning the handle 5, the pipe rod blades 9 pierces the sheets of paper.

Then punch wastes stay in the hollow space inside of the pipe rod blade 9, which increase in number by further punching. The punch wastes accumulated inside the blade are pushed up gradually to be discharged from the upper end of the pipe rod blade 9 and collected in the waste receptacle 11 through the discharge guide 16 and the sliding plate 17.

Now, the total weight of the punch 1 is intentionally set heavy so as to stabilize the center of gravity of the punch 1 against the force applied by the operation of turning the handle 5. Furthermore, since the waste receptacle 11 is accommodated in the operation stand 3, it has to be done from the back of the punch (from the side opposite to the base 2) avoiding the rotating shaft 4 and the rack 13 to take out the waste receptacle 11, Therefore, it is troublesome to take out the waste receptacle 11 because the heavy punch has to be turned around so that taking out the waste receptacle 11 becomes easier, or it has to be brought out into a broad space. In addition, since the waste receptacle 11 is accommodated in the operation stand 3, the volume of the waste receptacle 11 has to be small, resulting in increasing the number of times of emptying the wastes. Moreover, since it is impossible to see from the front how much waste has been collected in the waste receptacle, the timing of emptying the wastes is difficult to judge.

### SUMMARY OF THE INVENTION

The present invention has been made in view of the above, and an object of the present invention is therefore to provide a punch in which the volume of the waste receptacle to collect the punch wastes is increased and the waste receptacle can easily be taken out without moving the whole punch.

In order to attain the above object, according to a first aspect of the present invention, there is provided a punch comprising a base and operation stands that have a handle to be pulled toward the base and are provided on one end of the base on which sheets of paper are put and punched by pipe rod blades depressed by pulling the handle toward the base, characterized in that an opening for discharging punch wastes is provided on a side of each of the operation stands above the pipe rod blades, and a waste receptacle for collecting the wastes therein is provided on the base so that the waste receptacle is communicated with the opening.

According to a second aspect of the present invention, there is provided a punch characterized in that operation stands are provided on one end of a base for each arm of the handle, said arm being rotatably provided on a rotating shaft that is arranged-along the horizontal direction of the operation stands, and a rod holder to which a cylindrical pipe rod blade is to be fitted is connected to the handle, and that a hole communicated with the cylindrical pipe rod blade is formed on one side of the rod holder, said opening is aligned with an opening formed on a side wall of the operation stand which is perpendicular to a handle turning plane and the punch wastes passing through the pipe rod blade are discharged from the opening.

According to a third aspect of the present invention, in the second aspect of the present invention, the punch is characterized in that a waste receptacle provided with a communication port connected to the opening of the operation stand is set on the base.

According to a fourth aspect of the present invention, in the second aspect of the present invention, the punch is characterized in that a waste receptacle having a pair of communication ports connected to a pair of openings provided inside a pair of operation stands, respectively, is set between the pair of operation stands.

### BRIEF DESCRIPTION OF THE DRAWINGS

In the accompanying drawings:

FIG. 1 is a perspective view of a waste receptacle of a punch according to an embodiment of the present invention;

FIG. 2 is a sectional view of a main part of a cover portion of the waste receptacle illustrated in FIG. 1;

FIG. 3 is a sectional view of a container portion of the waste receptacle illustrated in FIG. 1;

FIG. 4 is a side view of an operation stand of a punch according to an embodiment of the present invention;

FIG. 5 is a sectional view showing the inside of the operation stand illustrated in FIG. 4;

FIG. 6 is a front view of the operation stand shown in FIG. 4;

FIG. 7 is a perspective view of a punch according to an embodiment of the present invention;

FIG. 8 is a side view of the punch shown in FIG. 7;

FIG. 9 is a top view of the punch shown in FIG. 7;

FIG. 10 is a front view of the punch shown in FIG. 7;

FIG. 11 is a back view of the punch shown in FIG. 7;

FIGS. 12A and 12B are structural diagrams of a rod holder to be assembled into the punch illustrated in FIG. 7, where FIG. 12A is a side view thereof and FIG. 12B is a frontal sectional view thereof;

FIGS. 13A and 13B are structural diagrams of the rod holder to be assembled into the punch illustrated in FIG. 7, where FIG. 13A is a top view thereof and FIG. 13B is a bottom view thereof;

FIG. 14 is a perspective view of a conventional punch; and

FIG. 15 is a sectional view of the main part of the punch shown in FIG. 14.

### DESCRIPTION OF THE PREFERRED EMBODIMENTS

Hereinafter, an embodiment of the present invention will be described with reference to the accompanying drawings.

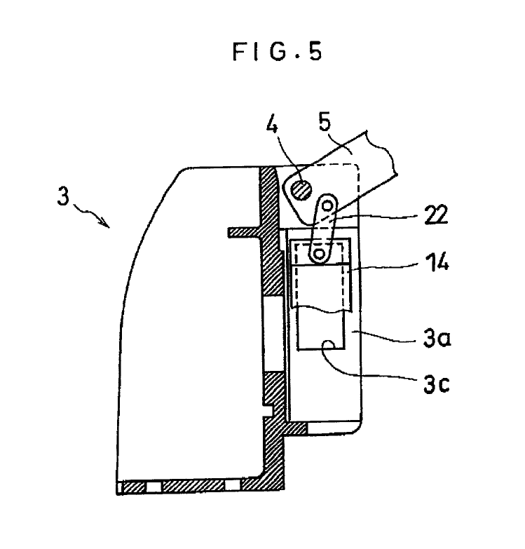

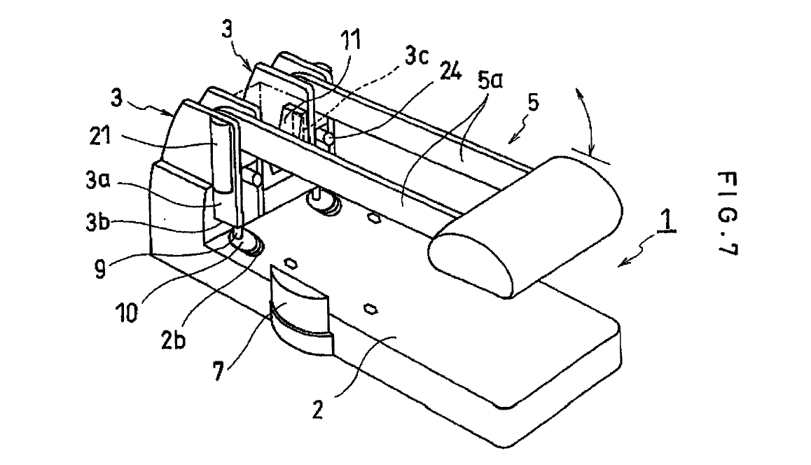

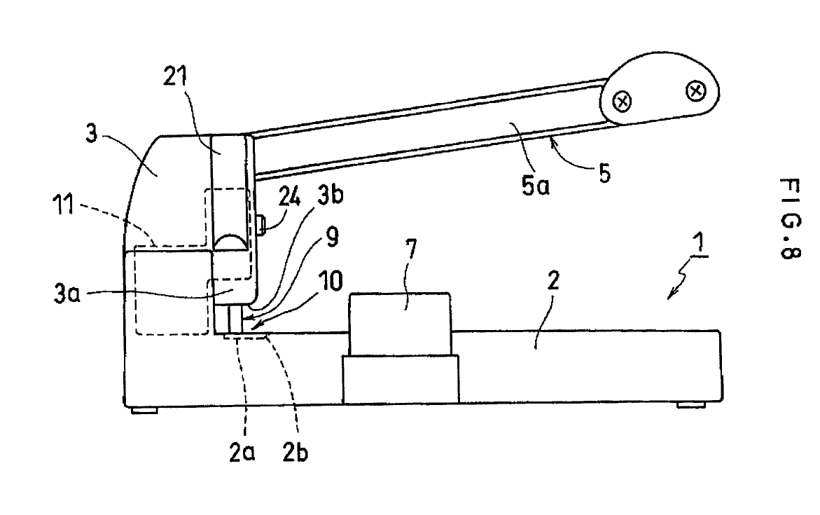

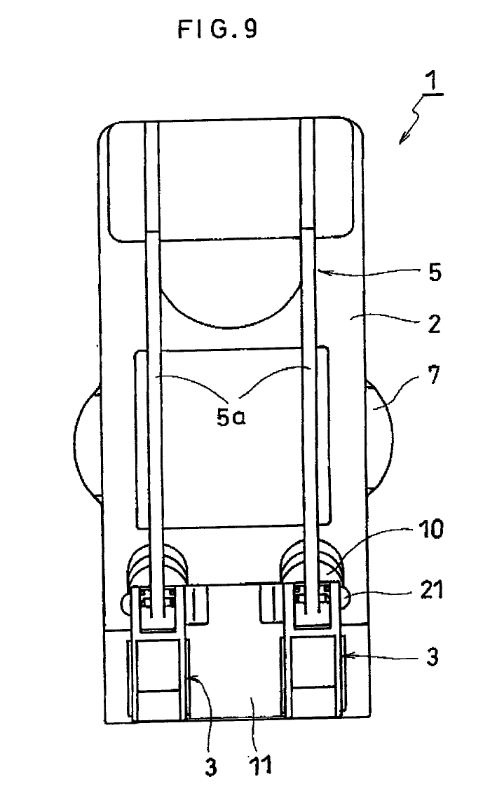

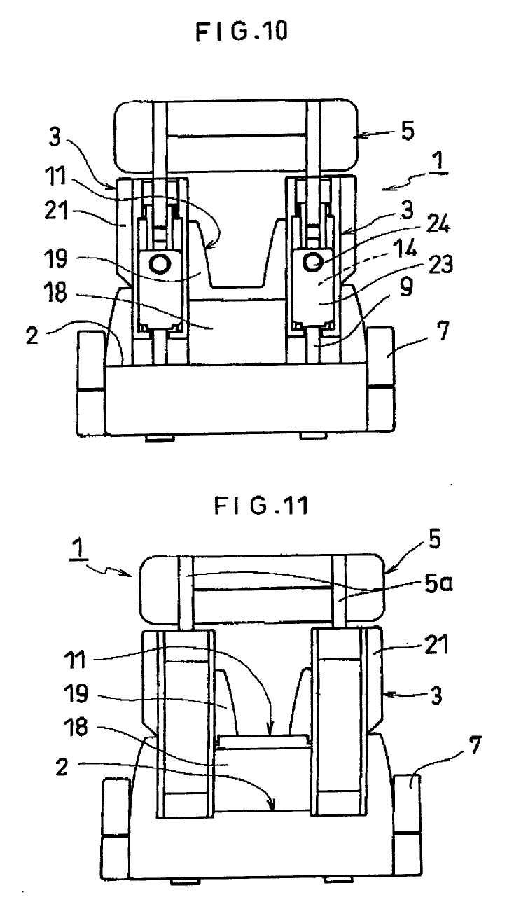

In a punch 1 shown in FIGS. 7 through 11, a pair of operation stands 3 are formed with an interval on an end of an approximately rectangular base 2 having a flat top face. The number of operation stands corresponds to the number of arms of the handle S. The handle 5 is provided rotatably on a rotating shaft 4 (see FIG. 5) arranged along the horizontal direction of the operation stand 3 so that the handle 5 is moved in an arc from above toward the base 2. Further, the handle 5 is normally kept upright by being biased with a spring within the operation stand 3.

On both sides of a portion of the base 2 on which sheets of paper are put, a gauge 7 is disposed in order to facilitate positioning for punch holes by aligning the edges of the sheets of paper to be punched.

A rod holder 14 to which a pipe rod blade 9 is to be fitted is provided on the operation stand 3, and the pipe rod blade 9 is set such that it looks downward at the top face of the base 2 below from a ceiling portion 3b of the operation stand 3. On the top face of the base 2 under the pipe rod blade 9, a recessed portion 2a for a rod guard 10 is provided, and a semi-circle portion on a side. wall of the recessed portion 2a is tapered to form a tapered portion 2b that connects the top face of the base 2 with the bottom of the recessed portion 2a.

A waste receptacle 11 is disposed between a pair of operation stands 3. The side faces of the waste receptacle 11 facing the operation stands 3 each have an opening 3c (see FIG. 4) communicated with the interior of the waste receptacle 11. The waste receptacle 11 is made of a transparent resin so that the interior of the waste receptacle 11 can be seen from the operator (from the front), and a shape that allows the waste receptacle 11 to be easily taken out upward or toward the front (toward the base 2).

Next, details of the waste receptacle 11 will be explained.

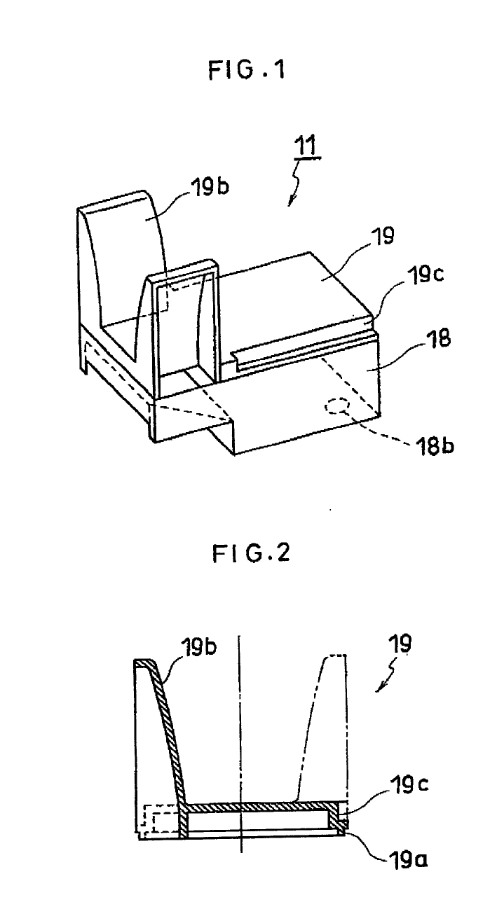

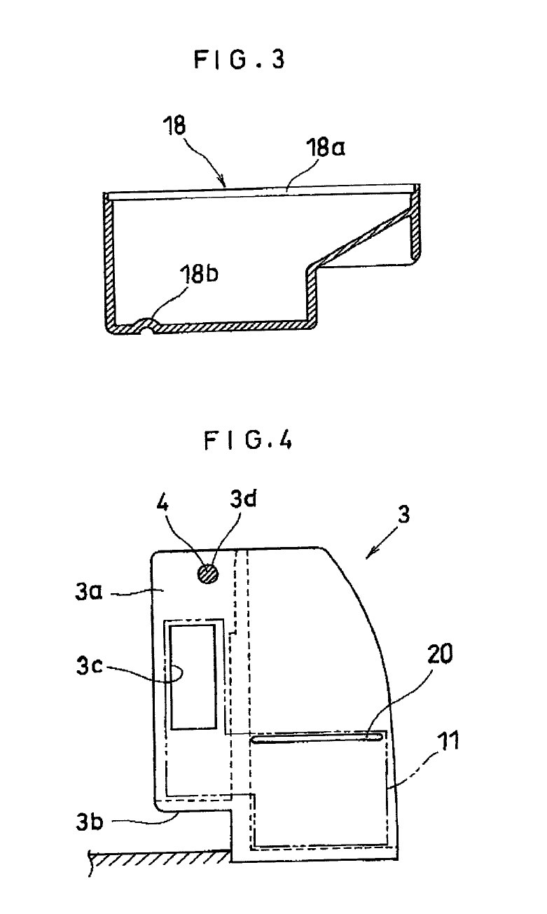

As shown in FIGS. 1 through 3, this waste receptacle is composed of an open top square container 18 and a cover 19 thereof. The container 18 is provided with an engagement groove 18a in its inner perimeter that is overlapped with the cover 19. Inside the container 18, there is a slope sloped toward the back of the container 18, so that the punch wastes are easily accumulated in the rear bottom of the container 18. Further, on the rear bottom of the container 18, a positioning recessed portion 18b is provided to engage a projection (not shown) provided on the base 2.

The cover 19 is provided with a projection 19a that protects downward and is positioned a little inside the perimeter of the cover 19 which is overlapped with the container 18. On both sides of the front upper face of the cover 19, there are windows covered with ears (communication ports) 19 extended sideward, thereby obtaining communication with the interior of the container 18. Formed on both sides of the rear upper face of the cover 19 are groove portions 19c which are to be loosely fit with linear projections 20 (see FIG. 4) of the side walls of the operation stands 3.

Next, the operation stand 3 will be explained.

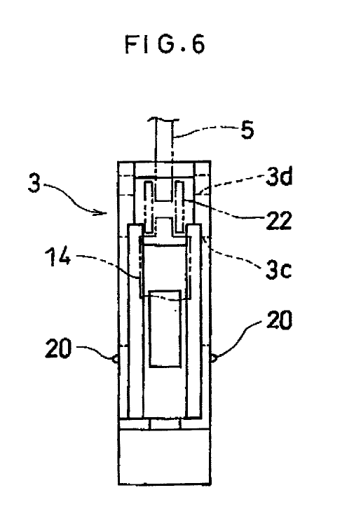

As shown in FIGS. 4 through 6, side walls of each of the operation stands 3 have rectangular openings 3c formed on projected portions 3a. Above the openings 3c, a hole 3d for supporting a rotating shaft 4 is provided. On the rear portion of the side wall of each of the operation stands 3, the linear projection 20 for holding the waste receptacle 11 is provided. Now, in the operation stand, two side walls are used, but, since the outer side wall does not need the opening 3c, the opening is covered with an ornament plate 21 (see FIG. 7).

The operation stand 3 holds the rod holder 14 in a manner that allows the rod holder 14 to move up and down, and the handle 5 and the rod holder 14 are connected with a link 22. In the lower limit position (approximately horizontal) of the handle 5, the upper fulcrum of the link 22 is located, in the horizontal direction, at a point between the center line of the rod holder 14 and the perpendicular line drawn from the rotating shaft 4.

Next, details of the rod holder 14 and the pipe rod blade 9 will be explained.

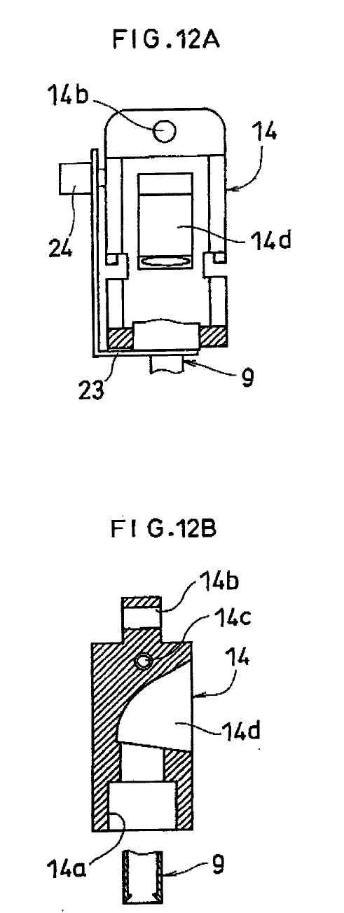

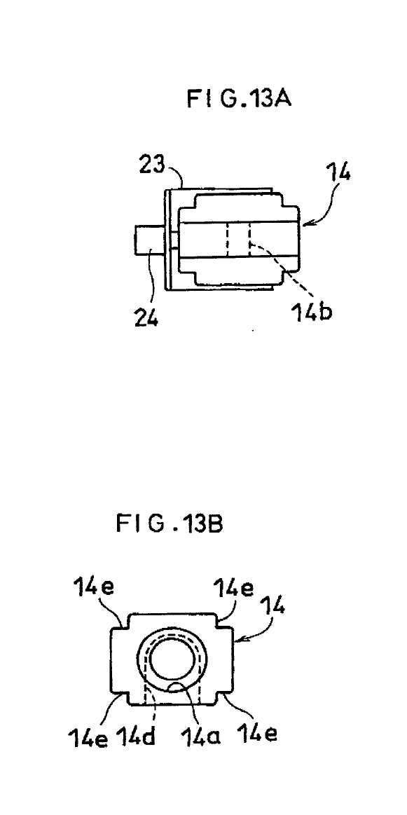

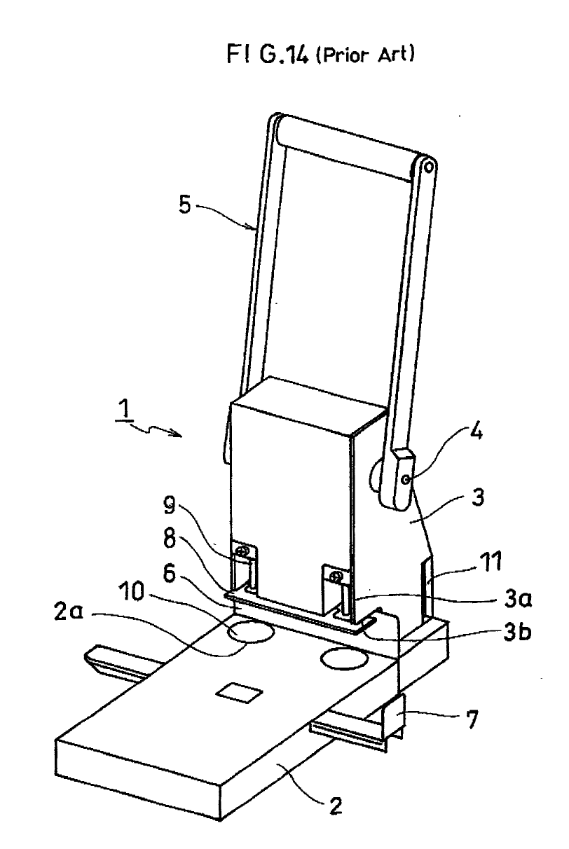

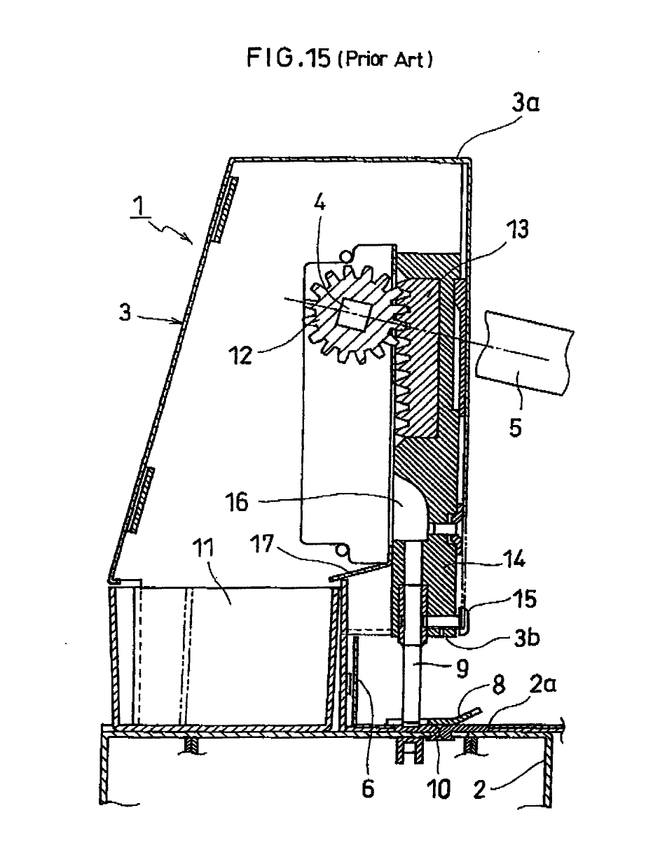

As shown in FIGS. 12A through 13B, the rod holder 14 is shaped into an angular column and has on its bottom a circular hole 14a to which the pipe rod blade 9 is fitted.

The upper portion of the rod holder 14 on the left and right is chipped and reduced in thickness. A communication hole 14b for the link 22 is formed in this thinned portion, and a screw hole 14c for fixing the pipe rod blade 9 is provided below and perpendicular to the communication hole 14b. Formed in the middle of the side face of the rod holder 14 is an opening 14d whose shape in section is like a fan with its apex set inward and the bottom outward. The opening 14d is communicated with the circular opening 14a formed in the bottom of the rod holder 14.

Further, as shown in FIGS. 13A and 13B, vertical grooves 14e are provided at four corners of the rod holder 14. This makes, it possible for the rod holder 14 to be guided vertically along a C-shaped frame (a resin made sliding guide) (not shown) of the operation stand 3.

The pipe rod blade 9 is, as shown in FIG. 12A, enlarged in diameter at a portion where it is fitted to the rod holder 14 and, as shown in FIGS. 12A and 13A, an L-shaped bracket 23 split at its tip fixes the pipe rod blade 9 to the holder 14. As seen in FIG. 12B, the tip the pipe rod blade 9 has edges, which makes an inner diameter of the pipe rod blade 9 at this portion reduced. However, the diameter of the pipe rod blade 9 is increased above this portion, whereby the wastes of punched sheets of paper smoothly passes through the pipe rod blade 9.

The punch 1 of the present invention is structured as above and when punching sheets of paper, the sheets of paper are put on the base 2 under the pipe rod blade 9 and, by flushing the edges of the sheets of paper with the gauge 7, the position to be punched is determined.

Then, by pulling the handle 5, the plate 8 and the pipe rod blade 9 descend to hold and punch the sheets of paper. The pipe rod blade 9 is pressed against the rod guard 10 and cuts into it a little bit before the blade stops. The punch wastes of the sheets of paper are thus pushed into the interior of the pipe rod blade 9 and holes are punched in the sheets of paper.

The punch wastes pushed into the pipe rod blade 9 gradually slide up as punching is repeated, and are discharged from the opening 14d of the rod holder 14. The punch wastes are then discharged from the opening 3c of the operation stand 3, received by the ears 19 of the waste receptacle 11 disposed by the side of the operation stand 3, fall down the slope of the container 18, and collected in the waste receptacle 11.

Thus, since the pipe rod blade 9 is made possible to move up and down with a simple link mechanism, the operation stand 3 provided for each arm can be made thin and, accordingly, one waste receptacle 11 can be set between a pair of operation stands for a pair of arms.

Accordingly, the punch wastes are discharged from the side faces of the operation stands 3 and can be collected in the waste, receptacle 11 disposed by the side of the operation stands. The punch wastes collected in the waste receptacle 11 can be seen from the outside, and, when emptying the wastes, only the waste receptacle 11 can be taken out upward or toward the front (toward the base) without moving the whole punch. In addition, since the waste receptacle is located on the base 2, the shape thereof is free to design, and its capacity can be increased as compared with the conventional type that is accommodated under the base 2.

Further, when changing the rod guard 10, the tapered portion 2b formed in the recessed portion 2a of the base 2 will make it easier to attach or detach the rod guard 10.

In addition, the number of the pipe rod blades 9 and the arms 5a associated with the blades may be increased together with the operation stand 3 to make a punch capable of punching three or more holes. Then the waste receptacle 11 has to be disposed every two adjacent operation stands 3.

Thus, according to the first aspect of the present invention, punch wastes are discharged from the side opening of the operation stand onto which the rotating shaft of the handle is pivoted and collected in the waste receptacle on the base. Therefore, the accumulated waste volume is easy to see and the waste receptacle can be detached from the near side without moving the whole punch. This makes the punch very user-friendly.

According to the second aspect of the present invention, the operation stand onto which the arm of the handler which is to operate the punch when punching sheets of paper, is pivoted is provided on the base with an interval for each arm. The waste receptacle can thus be disposed between the operation stands on the base. Further, the punch wastes are pushed through the pipe rod blade, moved toward the side opening of the rod holder, and discharged from the side opening of the operation stand. It is thus possible to collect the punch wastes in the waste receptacle disposed by the side of the operation stand. In addition, the shape of the waste receptacle is free to design and the capacity thereof:can be increased.

According to the third aspect of the present invention, the communication port of the waste receptacle makes it possible to securely collect the punch wastes discharged from the side opening of the operation stand. Moreover, how much waste has been accumulated is easily known and the waste receptacle can be removed without moving the whole punch, thereby making the punch very user-friendly.

According to the fourth aspect of the present invention, since the waste receptacle is set between a pair of operation stands, the waste receptacle can be held to the side faces of the operation stands, and the openings of the operation stands and the communication ports of the waste receptacle may be connected easily by merely placing the waste receptacle. This makes the punch very user-friendly.

What is claimed is:

1. A punch comprising a base and operation stands that have a handle to be pulled toward the base and are provided on one end of the base on which sheets of paper are put and punched by pipe rod blades depressed by pulling the handle toward the base,
wherein an opening for discharging punch wastes is provided on a side of each of the operation stands above the pipe rod blades, and a waste receptacle for collecting the wastes therein is provided on the base so that the waste receptacle is communicated with the opening.

2. A punch wherein operation stands are provided on one end of a base for each arm of the handle, said arm being rotatably provided on a rotating shaft that is arranged along the horizontal direction of the operation stands, and a rod holder to which a cylindrical pipe rod blade is to be fitted is connected to the handle, and
wherein a hole communicated with the cylindrical pipe rod blade is formed on one side of the rod holder, said opening is aligned with an opening formed on a side wall of the operation stand which is perpendicular to a handle turning plane and the punch wastes passing through the pipe rod blade are discharged from the opening.

3. A punch according to claim 2, wherein a waste receptacle provided with a communication port connected to the opening of the operation stand is set on the base.

4. A punch according to claim 2, wherein a waste receptacle having a pair of communication ports connected to a pair of openings provided inside a pair of operation stands, respectively, is set between the pair of operation stands.
